(19) United States
(12) Patent Application Publication
(10) Pub. No.: US 2016/0305161 A1
(43) Pub. Date: Oct. 20, 2016

(54) MORTISE LOCKSET

(71) Applicant: NANZ CUSTOM HARDWARE, INC., New York, NY (US)

(72) Inventor: Stephen V. McMAHON, Sag Harbor, NY (US)

(21) Appl. No.: 14/806,440

(22) Filed: Jul. 22, 2015

Related U.S. Application Data
(60) Provisional application No. 62/148,690, filed on Apr. 16, 2015.

(51) Int. Cl. E05B 63/08; E05C 1/16

(52) U.S. Cl. CPC E05B 63/08; E05C 1/16

(57) ABSTRACT

A mortise lock including a housing; a hub disposed in the housing; a latch disposed in the housing and operable to be displaced by a rotation of the hub between a latched position where a bolt portion of the latch extends through the first side face of the housing and a retracted position wherein the bolt portion is contained within the housing; and a gas spring disposed in the housing and coupled to the hub. A mortise lock assembly including a housing; a hub disposed in the housing; a latch disposed in the housing and operable to move between a latched position and a refracted position; a gas spring disposed in the housing and coupled to the hub; and a strike plate including at least one magnet. A method including rotating a handle of a mortise lock to compress a gas spring in a housing of the lock.

### CROSS-REFERENCE TO RELATED APPLICATION

The application is a claims the benefit of the earlier filing date of co-pending U.S. Provisional Patent Application No. 62/148,690, filed Apr. 16, 2015 and incorporated herein by reference.

### FIELD

Mortise locks or latches.

### BACKGROUND

A mortise lock is a lock that is positioned in a pocket or mortise in a lock edge of a door. The lock is concealed and to some degree protected by the exterior and. interior faces of the door. Components of a mortise lock generally include a housing or body (the part installed inside the mortise cut-out in the door); a non-locking spring latch disposed in the housing or body and operated by a rotation of a door handle (e.g., knob, lever); an optional locking latch or bolt disposed in the housing or body; a face plate connected to a side face of the housing or body that is generally set flush with the edge of the door, the face plate including an opening for the spring latch and optional locking latch or bolt; and a strike plate that aligns a hole in the door jamb into which the spring latch fits and optionally a hole in the jamb into which the locking latch or bolt fits. With regard to the spring latch, a housing of a mortise lock generally includes a hub connected to door handles on opposite faces of the door through a spindle. The hub transfers the rotational force of a door handle to retract the spring latch. A return spring is connected to the hub to generally spring load the hub. When a rotational force of the handle is applied, the return spring compresses and the spring latch is retracted toward the housing. When the rotational force is released, the return spring extends, the hub rotates back and the latch extends.

### BRIEF DESCRIPTION OF THE DRAWINGS

FIG. 1 shows a side perspective view of a portion of a door including an embodiment of a mortise lock in the door, handles connected to the mortise lock and a portion of a jamb having a strike plate therein;

FIG. 2 shows an exploded top side perspective view of the mortise lock of FIG. 1, a spindle to connect handles to opposite sides of the mortise lock and a strike plate, the mortise lock including a latch in a stowed or retracted position;

FIG. 3 shows an exploded top side view of the assembly of FIG. 2 with the latch of the mortise lock in an extended position;

FIG. 4 shows a top side perspective view of the housing of the mortise lock of FIG. 2.

FIG. 5 shows a cross-sectional side view of an assembly including the mortise lock of FIG. 2 in a door and the latch of the mortise lock in a stowed or retracted position;

FIG. 6 shows a cross-sectional side view of an assembly including the mortise lock of FIG. 2 in a door and the latch of the mortise lock in an extended position;

FIG. 7 shows the a side view of the assembly of FIG. 1 and a partial cross-sectional side view of the latch assembly and a corresponding chamber in the strike plate and the magnetic attraction between the latch assembly and the strike plate;

FIG. 8 shows a top view of the mortise lock of FIG. 1 and shows a faceplate rotated clockwise with respect to the strike plate;

FIG. 9 shows a top view of the mortise lock of FIG. 1 and shows a faceplate centered with respect to the strike plate; and

FIG. 10 shows a top view of the mortise lock of FIG. 1 and shows a faceplate rotated counterclockwise with respect to the strike plate.

### DETAILED DESCRIPTION

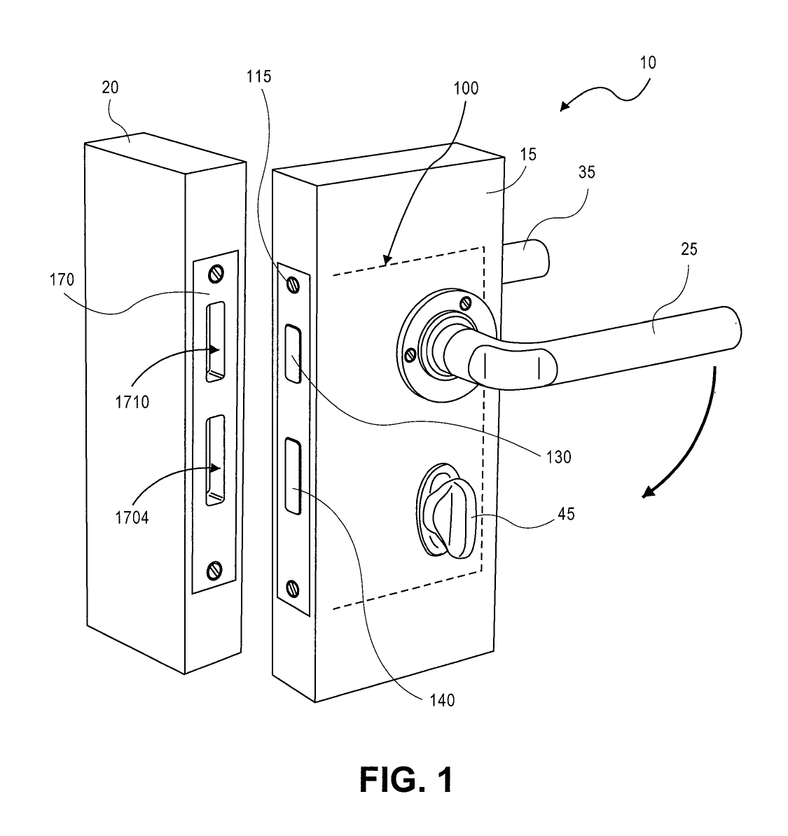

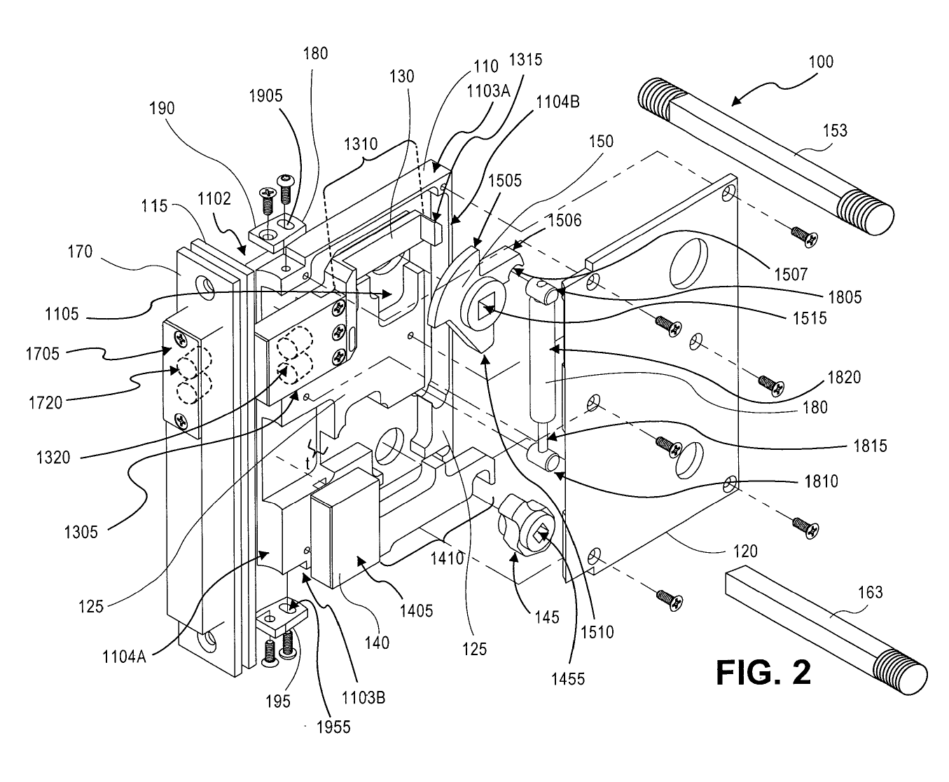

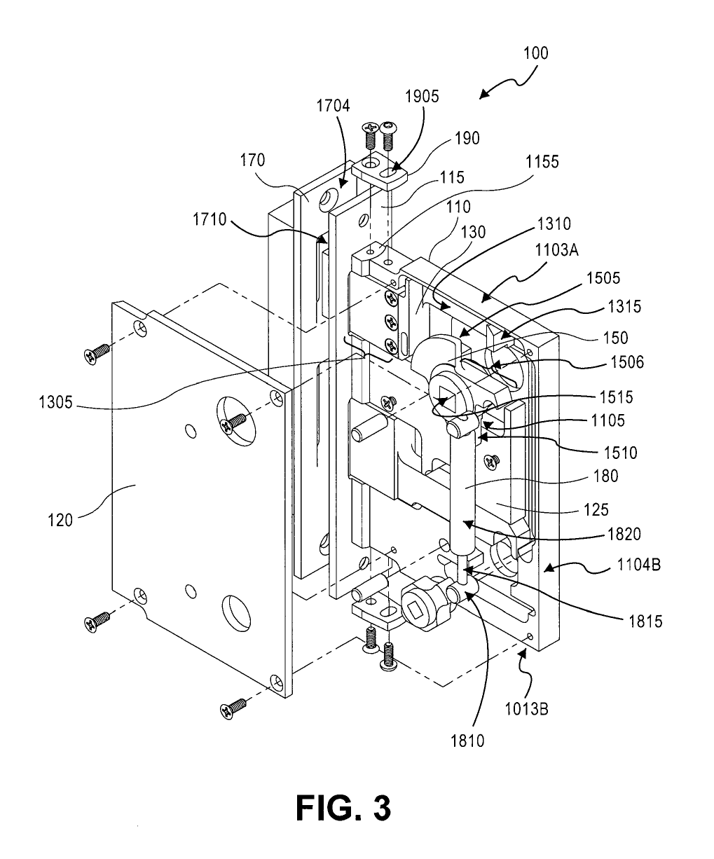

A mortise lock or latch, its method of manufacturing and use is disclosed. FIG. 1 shows one embodiment of a mortise lock assembly including a lock housing or body installed in a door with a corresponding strike installed in a jamb of the door and handles (e.g., levers) connected to the lock housing on opposite faces of the door. FIG. 2 and FIG. 3 illustrate exploded top side views of the lock and the strike with a latch of the lock in a stowed (retracted) position and an extended or thrown position, respectively.

Referring to FIG. 1, assembly 10 includes door 15 that is, for example, a wooden door and jamb 20. An edge of door 15 is mortised or cut out to accept lock 100 and a face of jamb 20 is mortised to accept strike 170. Lever 25 is connected to lock 100 on one side or face of door 15 and lever 35 is connected to lock 100 on an opposite side or face of the door. FIG. 1 also shows thumbturn 45 on the side of the door including lever 25. Thumbturn 45 is likewise connected to lock 100.

Referring to FIGS. 2-4, in this embodiment, lock 100 includes housing 110 that is operable to be installed inside a mortise cut-out of a structure including, for example, in a door such as door 15 (FIG. 1). Housing 110 is connected to faceplate 115 that itself may be inset in an edge of the door (e.g., inset so that a side of faceplate 115 is flush with the edge of the door).

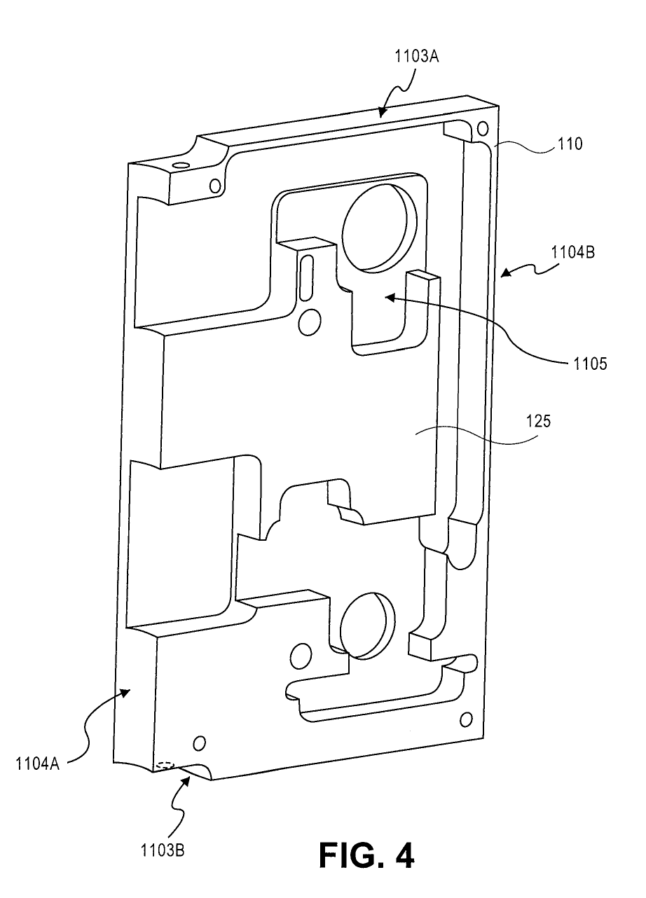

Housing 110 includes front plate 1102, opposing top face 1103A and bottom face 1103B as well as opposing side face 1104A and side face 1104B. Back plate or cover plate 120 connects to housing 110 on a side opposite front plate 1102. Specifically, back plate or cover plate 120 connects to the top and bottom faces and opposing side faces to define a closed structure. In one embodiment, front plate 1102, top face 1103A, bottom face 1103B, side face 1104A and side face 1104B of housing 110 are a unitary body of, for example, brass that is a single machined unit or part. FIG. 4 illustrates housing 110 as a unitary body. In another embodiment, individual faces are assembled to form housing 110. In one embodiment, for use of lock 100 in a door, representative dimensions of housing 110 include a height dimension of 4.75 inches, a width dimension of 3.096 inches and a thickness dimension of 0.375 inches. Faceplate 115 is connected to side face 1104A. In one embodiment, faceplate 115 has a representative height dimension of 6.0 inches, a width dimension of 1.0 inch and a thickness dimension of 0.125 inch.

Front plate 1102 and top face 1103A, bottom face 1103B, side face 1104A and side face 1104B of housing 110 define a body having a cavity or cavities therein that is(are) operable to contain components of the mortise lock. In one embodiment, disposed within the cavity defined by housing 110 is spacer 125 having a thickness dimension, t (see FIG. 2). In one embodiment, where front plate 1102, top face 1103A, bottom face 1103B, side 1104A and side face 1104B are a solid unitary piece of material (e.g., brass) defining a housing body, spacer 125 is also a part of the lock body. In one embodiment, where spacer 125 is a portion of the unitary body (see FIG. 4) having one or more cavities, such one or more cavities are formed by removing material from the body, such as by computer controlled machining techniques (e.g., CNC machining) In another embodiment, where housing 110 is not formed of a unitary body, a spacer having a desired shape may be inserted in the housing and connected thereto.

In the embodiment shown in FIGS. 2-4, spacer 125 includes cavity 1105 having a U-shaped portion. The U-shaped portion of cavity 1105 is defined by opposing sidewalls and a base of spacer 125. Disposed within cavity 1105 is hub 150. Hub 150 includes opening 1515 operable for spindle 153 to be inserted therethrough. Opposite ends of spindle 153 are operable to protrude from front and back sides of door 15 (see FIG. 1). Respective levers 25 and 35 are attached to spindle 153 (see FIG. 1).

Referring to hub 150 in FIG. 2 and FIG. 3, the hub includes three generally planar protrusions: quarter protrusion 1505 having a quarter arch shape extending in a nine o'clock to 12 o'clock orientation relative to a center of hub 150 as viewed; protrusion 1506 extending in a rearward or three o'clock direction (a direction away from faceplate 115) as viewed; and blunt protrusion 1510 extending in a downward or six o′clock direction as viewed.

In one embodiment, hub 150 is disposed in cavity 1105 in spacer 125 against a back side of front plate 1102 of housing 110. Blunt protrusion 1510 of hub 150 extends into the U-shaped portion of cavity 1105.

Also positioned within cavity 1105 of housing 110 is latch or bolt 130. Latch 130 includes bolt portion 1305 and tail portion 1310. In one embodiment, bolt portion 1305 of latch 130 has a height dimension of a 1.0 inch and a width and length dimension of 0.38 inch. Tail portion of latch 130, in one embodiment, extends in a direction toward a rear of housing 110 (in a direction toward side face 1104B) giving the overall latch a representation height dimension of 1.31 inches (bolt portion 1305 (1.0 inch) plus tail portion 1310 (0.31 inches) and a length dimension of 3.08 inches. Extending in a perpendicular direction away from a back side of front plate 1102 at a rear end of tail portion 1310 is protrusion 1315. In one embodiment, tail portion 1310 of latch 130 is disposed between front sidewall 1102 and quarter protrusion 1505 of hub 150. From a perspective of facing a back side of front plate 1102 into the housing as in FIG. 2 or FIG. 3, when hub 150 is rotated in a clockwise direction, quarter protrusion 1505 can contact protrusion 1315 of latch 130.

Also contained within housing 110 of lock 100 is gas spring 180. Gas spring 180 includes cylindrical body 1820 containing a gas compressed by a piston. The piston is inside cylindrical body 1820 and is connected at one end to rod 1815 (see FIG. 3). Gas spring 180 also includes bearing 1805 at one end of the piston and bearing 1810 at a second end of the spring. FIG. 2 and FIG. 3 shows rod 1815 connected to bearing 1810. Bearing 1805 is operable to engage hub 150. As noted above, hub 150 includes protrusion 1506 extending in a direction toward the rear of housing 110 as viewed. A base of protrusion 1506 includes cavity 1507. In this embodiment, bearing 1805 of gas spring 180 is operable to engage hub 150 through the contact of bearing 1805 in cavity 1507. In one embodiment, cavity 1505 of hub 150 has an arch or concave shape to mate with a cylindrical shape of bearing 1805 so that hub 150 may rotate on bearing 1805. Bearing 1810 of gas spring 180 is nested in a cavity in housing 110 with a portion of spacer 125 providing a support base. Bearing 1810, in one embodiment, has a cylindrical shape and an edge of spacer 125 has an arch or concave shape to mate with bearing 1810. As viewed, gas spring 180 is mounted in a vertical position (e.g., parallel to side face 1104B).

Referring again to latch 130, the latch includes bolt portion 1305 that has a cavity therein to contain magnet(s) 1320, in one embodiment, two or more magnets (see FIG. 2). Bolt portion 1310 has dimensions to fit within an opening in strike plate 170. In one embodiment, strike plate 170 includes face portion 1704 that is inset in a jamb and is flush with jamb 20 and connected thereto by fasteners (e.g., screws) (see FIG. 1). Disposed within strike plate 170 is chamber 1710 having opening dimensions (height and width dimensions) to accommodate bolt portion 1310 therethrough. Chamber 1710, in one embodiment, is defined by sidewalls and a base all of which are inset into the jamb. A representative height dimension of the opening is 1.375 inches to accept bolt portion 1305 of latch 130 of 1 inch and a depth of 0.375 inch. The base of chamber 1710 includes pocket 175. One or more magnets 1720 of an opposite polarity, in one embodiment, are disposed in pocket 1705 of strike plate 170. In one embodiment, magnet(s) 1720 includes two or more magnets. Suitable magnets are rare earth magnets such as neodymium magnets.

In a latched position, when latch 130 is disposed in jamb 20 (see FIG. 1) by way of being disposed in chamber 1710 in strike plate 170, the magnetic attraction between magnet(s) 1320 and magnet(s) 1720 retain the latch in an extended or latched position. Rotating of lever 25 or lever 35 (see FIG. 1) attached to spindle 153 rotates hub 150. From a perspective of facing a back side of front plate 1102 as in the view of FIG. 2 and FIG. 3, rotation of hub 150 in a clockwise direction by, for example, lever 25, causes an edge of quarter protrusion 1505 of hub 150 to contact protrusion 1315 of latch 130. Continued clockwise rotation directs (e.g., pulls) the latch away from jamb 20 in a direction toward door 15 and the rear of housing 110 toward side face 1104B of lock 100. Rotating of the lever causes hub 150 to pull latch 130 and overcome the magnetic attraction between magnet(s) 1320 and magnet(s) 1720). In one embodiment, a clockwise rotation of hub 150 may continue until an edge of blunt protrusion 1510 contacts a sidewall of the spacer in U-shaped cavity 1105. In one embodiment, an entire length of latch 130 including bolt portion 1305 is stowed in housing 110 when the latch is in a stowed position following the clockwise rotation of a lever.

With lever 25 rotated in a clockwise direction until an edge of blunt protrusion 1510 of hub 150 contacts a sidewall in U-shaped cavity 1105 and latch 130 pulled into housing 110 of lock 100, door 15 may be pulled or pushed away from strike plate 170. At that point, releasing of lever 25 will cause hub 150 to rotate in a counterclockwise direction so that a side of quarter protrusion 1505 of the hub no longer contacts protrusion 1315 of latch 130 (hub 150 and latch 130 are no longer in direct contact). A return force to cause the counterclockwise rotation of the lever is provided by gas spring 180 going from a compressed state to an extended state. The lever may rotate in a counterclockwise direction until blunt protrusion 1510 of hub 150 contacts a sidewall in U-shaped cavity 1105 of spacer 125 (a sidewall opposite the sidewall of U-shaped cavity 1105 blunt protrusion 1510 contacted following the clockwise rotation). As noted, latch 130 is free of hub 150. Nevertheless, latch 130 will stay in a stowed or depressed position so long as there is no magnetic attraction to extend it from its position. In one embodiment, one or more auxiliary magnets (not shown) may be placed within housing 110 (e.g., within spacer 125) that are of an opposite polarity to magnet(s) 1320 to assist in the retention of the latch in a stowed position. In one embodiment, any such auxiliary magnets have a magnetic field strength that is less than a magnetic field strength of magnet(s) 1720.

Once lever 25 has returned to its original position (e.g., a horizontal position as viewed in FIG. 1) by counterclockwise rotation, hub 150 is free to rotate without hitting protrusion 1315 and latch 130 is free to move in a forward direction, such as in response to a magnetic force. Thus, latch 130 moves forward (toward strike 170) in response to a magnetic attraction or magnetic force from the one or magnets in the strike plate and moves backward or is retracted in response to a rotation of a lever.

Referring to gas spring 180, in one embodiment, gas spring 180 provides resistance to a lever (lever 25 or lever 35). Referring specifically to lever 25, if latch 130 is in a latched or thrown position (FIG. 2), gas spring 180 is extended and depressing or rotating of lever 25 in a clockwise direction from a horizontal position as viewed in FIG. 1 is met by resistance from gas spring 180. Such resistance may be overcome by application of a force on lever 25 associated with rotating the lever. Continued rotation in a clockwise direction results in a sidewall of quarter protrusion 1505 of hub 150 contacting protrusion 1315 of latch 130 and continued rotation of gas spring 180 moves latch 130 rearward into housing 110 toward its stowed position. When latch 130 is in a stowed position (FIG. 3), gas spring 180 is compressed. Release of lever 25 (release of a force on lever 25) will cause gas spring 180 to extend, hub 150 to rotate counterclockwise to a neutral position that is not in contact with latch 130, and lever 25 to rotate in a counterclockwise direction back to a horizontal position. Subsequent depression (rotation) of lever 25 in a clockwise direction will be met with resistance from gas spring 180. In such instance, however, latch 130 will not move.

In one embodiment, a resistance offered by gas spring 180 can be tuned. A representative range of resistance is on the order of 60 Newtons (N) to 100 N resistance of an average resistance representatively being on the order of 80 N. Gas spring 180 provides a nearly constant force to its entire range of motion. Gas spring 180 also has a return or spring back that it is relatively slow compared to prior art compression spring or torsion spring. Thus, the use of a gas spring provides a lever with a different action than conventional door levers. In particular, the mortise lock incorporating a gas spring provides a relatively smooth and consistent resistance through its entire range of motion and does not transmit the kind of vibrations that can sometimes be created by the friction of a metal spring as it compresses.

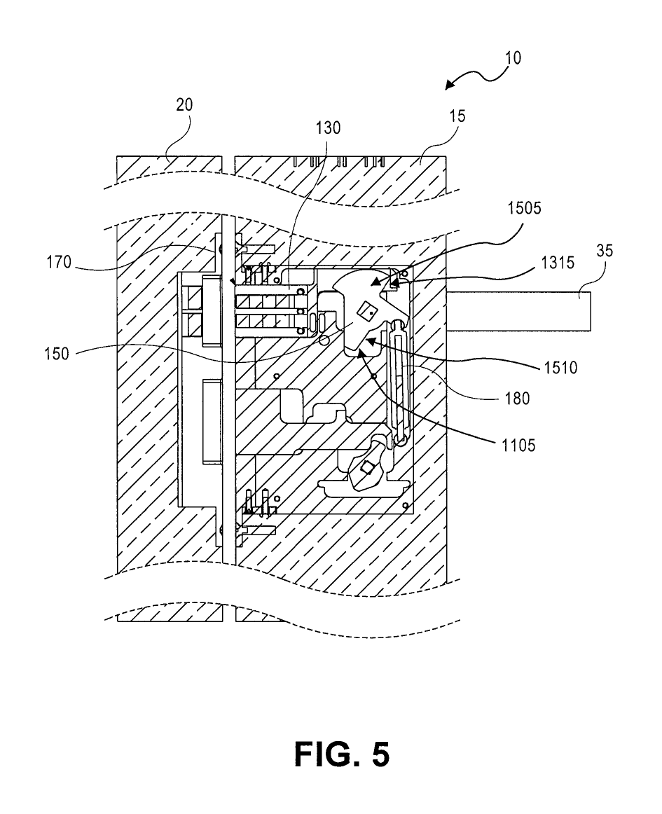

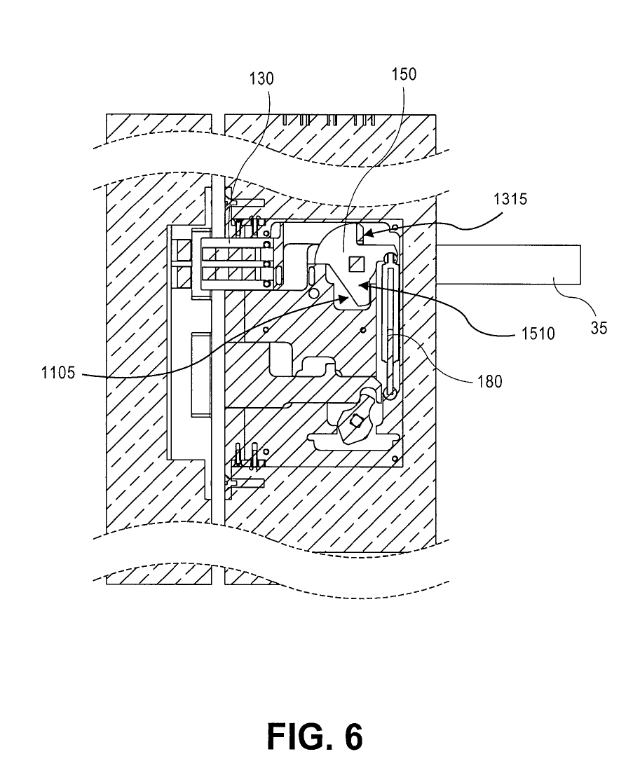

FIG. 5 shows a cross-sectional side view of assembly 10 with lock 100 including latch or bolt 130 in a retracted or stowed position. As viewed, gas spring 180 is in contact with hub 150 and is compressed. As illustrated in FIG. 5, hub 150 is rotated such that FIG. 5 also shows blunt protrusion 1510 of hub 150 contacting a first sidewall of U-shaped cavity 1105 in spacer 125. Once contact is made, hub 150 cannot rotate any further in a clockwise direction because of contact with the first sidewall. FIG. 6 shows a cross-section of assembly 10 with latch or bolt 130 in a latched or thrown position. As illustrated, when the latch or bolt is thrown, gas spring 180 is in contact with hub 150 and extended. FIG. 6 shows blunt protrusion 1510 contacting a second sidewall of U-shaped cavity 1105 in spacer 125. The second sidewall is opposite the first sidewall.

Referring again to FIGS. 1-3, in the embodiment illustrated, lock 100 includes privacy latch or bolt 140 within housing 110. In one embodiment, privacy latch 140 includes bolt portion 1405 and tail portion 1410. Tail portion 1410 extends from bolt 1405 in a direction toward side face 1104A. A rear end of tail portion 1410 includes a cavity through which hub 145 is positioned. Hub 145 includes opening 1455. Opening 1455 is operable to contain spindle 163 therethrough. Such spindle 163 may be connected to a thumbturn on one side of the door (e.g., an inside portion of a door) such as latch 45. Rotation of thumbturn 45 rotates hub 145 to move latch 140 in a forward direction and bolt portion 1405 into an opening in faceplate 170.

FIG. 7 shows a side view of assembly 10 and illustrates the magnetic field produced by magnet(s) 1320 of magnet(s) 1720.

Door edges are often beveled or angled, such as an angle of five degrees, so that the door engages with the jamb more easily. In one embodiment, a mortise lock has a faceplate that pivots to adjust to the door angle. Referring to FIG. 3, FIG. 3 shows faceplate 115 connected to side face 1104A of housing 110. As illustrated, side face 1104A has a curved surface, for example, a concave shape. In one embodiment, a back side of faceplate 115 includes protrusion 1155 protruding in a perpendicular direction from a back side of faceplate 115 (a side facing housing 110). Protrusion 1155 has a curved shape that mates to the curve of side face 1104A. As illustrated, protrusion 1155 has a convex shape to mate with a concave shape of side face 1104A. Faceplate 115 may be connected to housing 110 through tab 190 and tab 195. Tab 190 has curved or oval opening or slot 1905 and tab 195 has curved or oval opening or slot 1955. Faceplate 115 is attached to housing 110 through a fastener e.g., a screw) in slot 1905 and slot 1955, respectively. Each slot (slot 1905 and slot 1955) has space to allow a degree of travel of the respective sleeve (e.g., a five degree of travel in either direction). As the surface of curved faceplate 115 and side face 1104A travel against each other, a pivot point is established at the center of rotation in a front center of faceplate 115. In the prior art, any pivot of the faceplate or lock was accommodated by enlarging the slots in the face plate that accept latch or bolt 130 and privacy latch or bolt 140 in order to account for the sideways travel associated with a beveled faceplate. Where the front center of the faceplate is the pivot point, the necessary dimension changes of a sleeve through which a latch/bolt can travel needs only to be increased, if at all, by a few thousands of an inch or less. Such minimal dimension increase of a sleeve provides a tighter lock assembly when a latch/bolt is thrown.

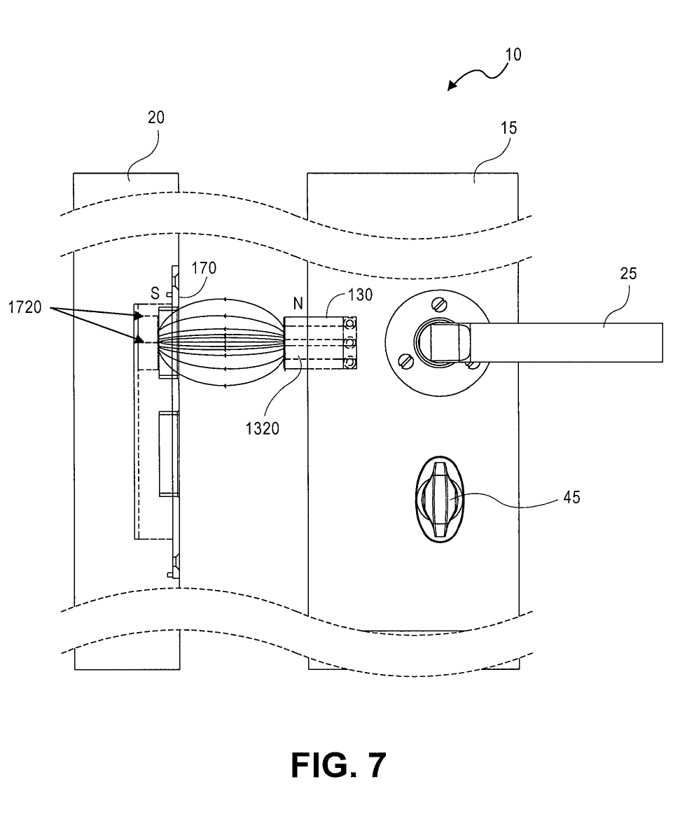

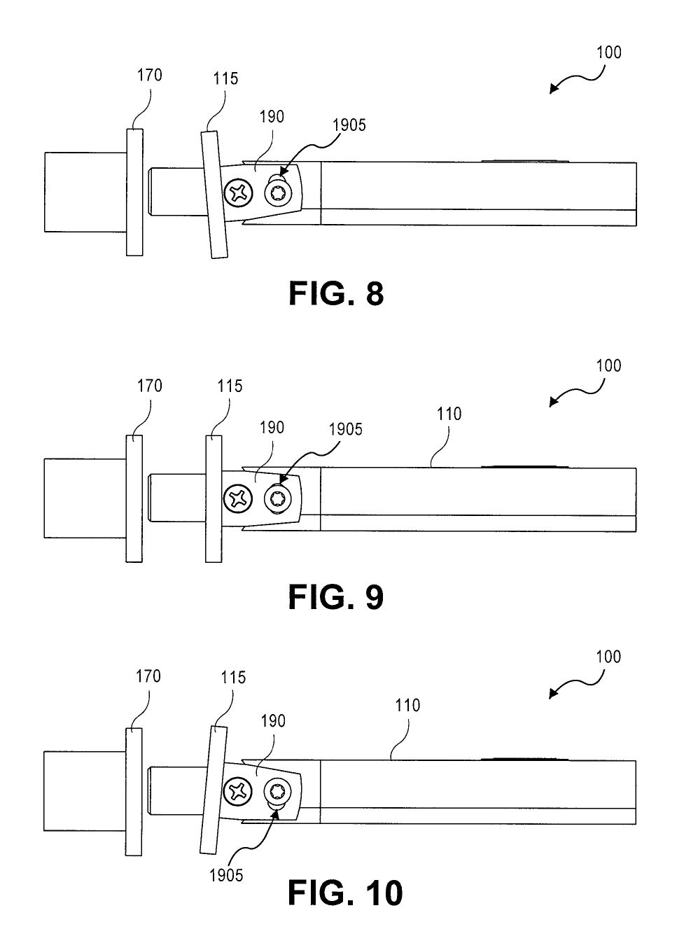

FIGS. 8-10 illustrate different rotations of a faceplate. FIG. 8 shows the first embodiment when faceplate 115 of lock 100 is rotated clockwise a few degrees. FIG. 8 shows the pivoting of tab 190. FIG. 9 shows faceplate 115 centered without a pivot. Finally, FIG. 10 shows faceplate 115 rotated a few degrees counterclockwise and the corresponding pivot of tab 190 in slot 1905.

In one embodiment, one or more components of lock 100 are formed of a solid metal (e.g., brass or stainless steel) using computer-aided machining techniques (e.g., CNC machining)

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. For example, a magnetic lockset having a gas spring is described. It is appreciated that a gas spring can be utilized in other types of mortise locksets. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. A mortise lock comprising:
a housing operable to be installed in a mortise cut-out of a structure, the housing comprises a front plate, opposing top face and bottom face, and opposing first side face and second side face;
a hub disposed in the housing;
a latch disposed in the housing and operable to be displaced by a rotation of the hub between a latched position where a bolt portion of the latch extends through the first side face of the housing and a retracted position wherein the bolt portion is contained within the housing; and
a gas spring disposed in the housing and coupled to the hub.

2. The mortise lock of claim 1, wherein the latch is operable to move from the retracted position to the latched position without contact by the hub.

3. The mortise lock of claim 1, wherein when the latch is in the retracted position, the hub is not in contact with the latch and the gas spring is in an extended position.

4. The mortise lock of claim 1, further comprising a handle coupled to the hub, wherein the hub is operable to be rotated by a rotation of the handle and, following a rotation of the handle from a first position to a second position operable to displace the latch to the retracted position, the bolt portion of the latch is operable to remain in the housing following a return of the handle to the first position.

5. The mortise lock of claim 4, wherein when the handle is in the first position, the hub is not in contact with the latch.

6. The mortise lock of claim 1, wherein the bolt portion of the latch comprises at least one magnet.

7. The mortise lock of claim 6, further comprising a strike plate operable to be mounted in a jamb of a door, the strike plate comprising a chamber having dimensions to accommodate the bolt portion of the latch and at least one magnet comprising a polarity opposite a polarity of the at least one magnet in the bolt portion of the latch.

8. The mortise lock of claim 1, wherein the gas spring comprises a resistance in the range of 60 Newtons to 100 Newtons.

9. The mortise lock of claim 1, wherein the housing comprises a unitary body comprising a front plate, a top face and an opposing bottom face, and a first side face and an opposing second side face, the body having at least one cavity formed therein, wherein in the hub, the latch and the cavity are disposed in the at least one cavity.

10. The mortise lock of claim 9, wherein the at least one cavity comprises a hub cavity comprising a U-shaped portion defined by a first wall, an opposite second wall and a base and the hub comprises a blunt protrusion that is disposed in the cavity and is operable to be rotated between the first wall and the second wall of the hub cavity.

11. The mortise lock of claim 1, wherein the housing comprises a front plate, a top face and an opposing bottom face, and a first side face and an opposing second side face, the mortise lock further comprising a faceplate coupled to the first side face of the housing, wherein the first side face comprises a concave shape and the faceplate comprises a protrusion protruding from a back side, the protrusion comprising a convex shape.

12. The mortise lock of claim 10, further comprising a tab comprising a first opening and a second opening therethrough, wherein the tab is coupled to the protrusion and the first side face by a fastener through each opening, wherein the opening in the tab for a fastener to couple the tab to the first side face is larger than the fastener providing the tab with a degree of travel.

13. The mortise lock of claim 12, wherein the protrusion is a first protrusion protruding from a first position of the face plate and the tab is a first tab, the mortise lock further comprising a second protrusion protruding from a back side at a second position different from the first position, the second tab comprising a convex shape and a second protrusion coupled to the second tab and the first side face by fasteners through each of two openings in the tab.

14. The mortise lock of claim 1, wherein the hub is a first hub, the mortise lock further comprising a privacy latch and a second hub disposed in the housing, wherein the privacy latch is operable to be displaced from a retracted position to an extended position by rotation of the second hub.

15. A mortise lock assembly comprising:
a housing operable to be installed in a mortise cut-out of a structure;
a hub disposed in the housing;
a latch disposed in the housing and operable to move between a latched position and a retracted position by a rotation of the hub;
a gas spring disposed in the housing and coupled to the hub; and
a strike plate operable to be installed in a jamb, the strike plate comprising at least one magnet that produces a magnetic field operable to displace the latch from the retracted position to the latched position.

16. The mortise lock assembly of claim 15, wherein the latch is free to move from the retracted position to the latched position without interference from the hub.

17. The mortise lock assembly of claim 15, wherein in the retracted position, a bolt portion of the latch is contained in the housing.

19. The mortise lock assembly of claim 15, further comprising a faceplate comprising at least one protrusion protruding from a back side, the at least one protrusion comprising a convex shape, the faceplate coupled through the at least one protrusion to a side face of the housing, wherein the first side face comprises a concave shape.

20. The mortise lock assembly of claim 19, further comprising at least one tab operable to couple the at least one protrusion to the side face, the at least one tab comprising a first opening and a second opening therethrough, wherein the tab is coupled to the protrusion and the side face by a fastener through each opening, wherein the opening in the tab for a fastener to couple the sleeve to the side face is larger than the fastener providing the tab with a degree of travel after coupling.

21. A method comprising rotating a handle of a mortise lock to compress a gas spring in a housing of the lock.

22. The method of claim 21, wherein the mortise lock comprises a latch, the latch comprising a bolt portion, wherein rotating the handle comprises rotating the handle until the bolt portion of the latch is in the housing of the lock.

23. The method of claim 22, wherein after rotating the handle, releasing the handle, wherein after releasing the handle, the bolt portion of the latch remains in the housing of the lock.
